(19) United States
(12) Patent Application Publication
(10) Pub. No.: US 2005/0234770 A1
(43) Pub. Date: Oct. 20, 2005

(54) Method and apparatus for generating user profile distinctions

(76) Inventors: Russell F. McKnight, Sioux City, IA (US); Glen J. Anderson, Sioux City, IA (US)

Correspondence Address: GATEWAY, INC.;ATTN: SCOTT CHARLES RICHARDSON, 610 GATEWAY DRIVE, MAIL DROP Y-04, N. SIOUX CITY, SD, 57049, US

(21) Appl. No.: 10/826,722

(22) Filed: Apr. 16, 2004

(51) Int. Cl. G06F 17/60

(52) U.S. Cl. 705/14

(57) ABSTRACT

A method and apparatus for generating a profile distinction associated with a computerized transaction between a user and a merchant, provide for determining if the transaction is associated with the user or a third party. Information associated with the transaction is aggregated in a profile corresponding to the user or according to a profile distinction associated with the third party if so determined. A special offer, a promotion, a product offering, a product recommendation, or a product suggestion tailored to the user or the third party is presented using the aggregated information associated with the transaction. If the profile distinction is not already present it is established and, if present, information is aggregated therein.

### BACKGROUND OF THE INVENTION

1. Field of the Invention

The present invention relates to automated marketing and the collection of demographic information, and more specifically to the generation of distinctions within user profiles.

2. Brief Description of the Related Art

As online shopping has become more pervasive, the use, by, for example, Internet based merchants, of information related to preferences of consumers, users, or the like has increased. Many examples can be found of Internet merchants collecting information on various aspects of on-line transactions including, for example, previous purchases of users or consumers, and the like. Use of such information to tailor specific offerings to consumers during subsequent shopping experiences has been a common historical practice in merchandising and marketing and has more recently been applied in an enhanced fashion through the use of computers and related connections to computerized shopping connections made possible by, for example, the ubiquity of the Internet.

Many systems are available for profiling consumers, particularly on the Internet. In U.S. Pat. No. 6,298,348 B1 issued on Oct. 2, 2001 to Eldering, for example, demographic characterizations and product preferences are stored and updated in a consumer profile to allow for targeted advertising. As can be seen, for example, in FIG. 1, a conventional system for storing profiles in connection with scenario 100 is illustrated. User #1 113, who is an online shopper or consumer, can connect to Internet 120 through computer 110 having a typical configuration including, for example, keyboard 111 and display 112. As will be appreciated by one of ordinary skill in the art, the connection to Internet 120 is carried out using some type of communication or connection equipment such as a cable modem or the like and a service connection provided by a service provider or the like. Since connection related equipment is well known to those of ordinary skill in the art, they are not shown. User #1 113 can connect with multiple merchants 130, such as merchant #1 130(a), merchant #2 130(b), merchant #3 130(c), up to merchant #N 130(n). Each merchant may establish, maintain, and update respective user #1 profiles 131(a), 131(b), 131(c), and 131(n).

Such information can be and is used to generate offers for related items, or the like, and to otherwise aid the on-line merchant in providing custom tailored services and product offerings to on-line shoppers. As the quantity of information stored in the consumer profile grows, the corresponding increase in the degree of specificity of the information has the potential to increase the quality of related offerings, e.g. resulting offers are more carefully tailored to preferences of the individual associated with the profile. Many on-line shoppers have come to depend on the user profiles created by Internet merchants or vendors to suggest future purchases of products based on information aggregated from past purchases. One related example would be an on-line bookseller offering suggestions for future purchases based on the past purchases of the user and the subsequent or concurrent purchases of other users who bought the same selection as the user. Such suggestions can often lead the user into areas of interest not previously explored, steer consumers toward new products which will likely be of interest, and expand existing interests by, for example, introducing the user to previously unknown products, authors, composers, performers, and the like, in an existing genre of interest.

Problems arise however in that on-line shopping transactions are often used for the purpose of making gift purchases for others. When such purchases are made for a spouse, for children and friends, or the like, the user profile may become distorted. Future recommendations are made based on aggregate interests characterized not only by including the users' shopping trends but by including the gifts purchased for others resulting in a profile which does not necessarily reflect the genuine interests of the user.

Consequently, it would be desirable for distinctions to be generated within a user profile to prevent or control the application of information to the profile which is added based on shopping experiences performed for others in the course of gift shopping or the like.

### SUMMARY OF THE INVENTION

Accordingly, a method and apparatus are provided for generating a profile distinction associated with a computerized transaction between a user and a merchant. The profile distinction allows information related to the transaction if made on behalf of a third party to be distinguished from information stored in connection with preferences uniquely associated with the user thus improving the accuracy of profile information stored for demographic purposes such as marketing and providing offers or the like.

In accordance with one exemplary embodiment, the present invention involves determining if the computerized transaction is being made or is otherwise associated with the user, or if the computerized transaction is being made or is associated a third party. It will be appreciated that it is useful to associate the transaction with the user even when being made on behalf of a third party since cross profile information may also be kept. Thus, information associated with the transaction may be aggregated in a profile corresponding to the user if the computerized transaction is determined to be associated with the user; and may be aggregated in the profile corresponding to the user according to a profile distinction associated with the third party if the computerized transaction is determined to be associated with the third party.

In accordance with another exemplary embodiment, one or more of: a special offer, a promotion, a product offering, a product recommendation, and a product suggestion, tailored to one or more of the user and the third party may be presented using the aggregated information associated with the transaction either during the course of the transaction or at the end of the transaction tailored toward the next transaction.

In accordance with still another exemplary embodiment it may be determined if the profile distinction associated with the third party is already present in the user profile. If not already present, the profile distinction associated with the third party may be established. If the profile distinction is already present, the information associated with the transaction may be aggregated in the profile distinction associated with the third party to further improve and refine information associated with purchases made by the user on behalf of the third party without compromising the accuracy of information already aggregated and associated with the user and the individual preferences thereof.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a diagram illustrating a conventional on-line shopping scenario where a consumer interacts with a merchant;

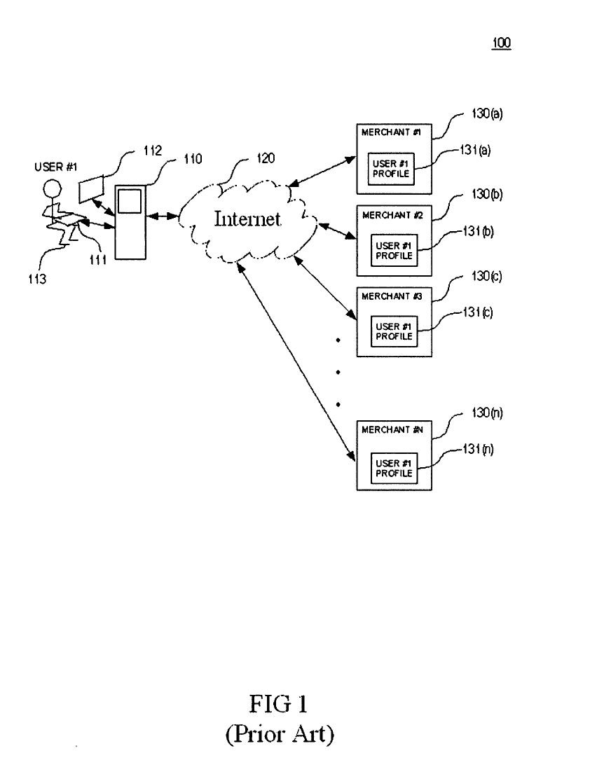

FIG. 2 is a block diagram illustrating an on-line shopping scenario in accordance with various exemplary embodiments, where a consumer interacts with a merchant aggregating a profile associated with the consumer and with a third party such as a giftee;

FIG. 3 is a block diagram illustrating an on-line shopping scenario in accordance with various exemplary embodiments, where a consumer interacts with a merchant aggregating a profile associated with the consumer and with multiple third parties such as giftees;

FIG. 4 is a flow chart illustrating exemplary procedures associated with various embodiments of the inventive method;

FIG. 5 is a block diagram illustrating an exemplary scenario wherein the inventive method is implemented in a processor associated with a merchant; and

FIG. 6 is a block diagram illustrating an exemplary scenario wherein the inventive method is implemented in a processor associated with a user.

### DETAILED DESCRIPTION OF THE INVENTION

Accordingly, the present invention in accordance with various exemplary embodiments, is directed to a method and apparatus for generating a profile distinction associated with a computerized transaction between a user and a merchant.

As described above, systems are known for compiling and aggregating consumer related data based on past transactions. However, when purchases for others are aggregated errors and distortions in the purchaser's profile may occur. Some systems are more complex and allow for analysis to correct or refine profiles. One proposed related approach to updating user profiles is described in U.S. Pat. No. 6,236,978 B1 issued on May 22, 2001 to Tuzhilin and the corresponding International Application WO 99/26180. Therein, a static user profile containing factual data can be combined with a dynamic user profile containing information associated with user transactions. A user or human expert may examine aggregated rules to select pertinent rules; however there is no provision for accounting for transactions performed on behalf of others.

In another proposed related approach, described in U.S. Pat. No. 6,327,573 B1, issued on Dec. 4, 2001 to Walker et al., rewards and demographic information may be generated on a single customer account having multiple users, such as family members or relatives. Relation history is kept for purposes of generating demographics on relations, e.g. sub accounts with similar transactional tendencies. Walker et al. makes no provision however, for distinguishing between transactions within the same account or sub-account made on behalf of third parties including other sub-accounts.

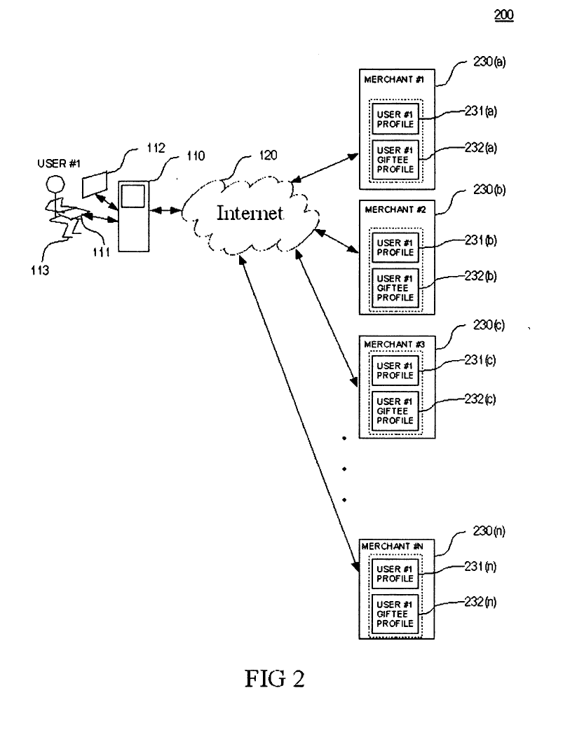

Thus the need is clearly present to allow for consumers and users to designate or otherwise establish distinctions within profiles to exclude information related to transactions conducted on behalf of third parties (TPs) such as giftees or the like from the user's own profile. Reference will now be made in detail to the presently preferred embodiments of the invention, examples of which are illustrated in the accompanying drawings. In FIG. 2 of the drawings, an exemplary scenario 200 is shown where user #1 113 connects in a typical fashion to Internet 120 using computer 110 having keyboard 111 and display 112, for example, as described herein above. User #1 113 can connect to any one of merchant #1 230(a), merchant #2 230(b) merchant #3 230(c), up to merchant #N 230(n). Merchants will keep corresponding profiles for user #1 113 such as user #1 profile 231(a) for merchant #1 230(a), user #1 profile 231(b) for merchant #2 230(b), user #1 profile 231(c) for merchant #3 230(c), up to user # 1 profile 231(n) for merchant # N 230(n). In accordance with various exemplary embodiments, merchant #1 230(a), merchant #2 230(b) merchant #3 230(c), and merchant #N 230(n) may further keep additional information associated with purchases or other transactions conducted on behalf of TPs such as giftees or the like which additional information may be referred to as a profile distinction, e.g. a distinction from the general profile associated with, for example, user #1.

Accordingly, giftee #1 profile distinction 232(a) may be kept by merchant #1 230(a), giftee #1 profile distinction 232(b) by merchant #2 230(b), giftee #1 profile distinction 232(c) by merchant #3 230(c), and giftee #1 profile distinction 232(n) by merchant #N 230(n). It will be appreciated that transaction information associated with a giftee may, in accordance with the invention, constitute a profile distinction within the user #1 profile and thus will be considered outside the scope of general user #1 profiles 231(a)-(n) and not aggregated with information associated with user #1 individual preferences. Further, individual and separate profiles, and profile distinctions may be kept and aggregated for giftees as for example profile distinctions kept in connection with giftee #1 232(a)-(n). It will be further appreciated that the keeping of profiles for giftees and third parties as in accordance with the present invention, and the like may be distinguished from basic keeping of profiles for users in that the unique sensibilities of a user making purchases on behalf of another party may be captures and refined. Also the information may be used in other ways. For example, the information captured associated with TP distinctions can conceivably be used to refine certain elements of the user # 1 profile based on refined demographic criteria. An example might include the application of demographic information such as people who bought gift A for a third party also bought item B for themselves, and the like.

As an additional example, if user #1 113 has a consistently unique sense of style when purchasing gifts for, for example, giftee #1, such a sense may be captured and refined and may fall outside the scope of purchases giftee might make for themselves. Thus gifts purchased for giftee #1 by user #1 113 may constitute an entirely unique demographic category. Particularly in instances where feedback by giftee #1 to user #1 113 is positive, user #1 113 may continue to reinforce their gift sense with regard to giftee #1 and strengthen the corresponding profile resulting hopefully in increasing levels of satisfaction on the part of giftee #1 with selections made by user#1 113.

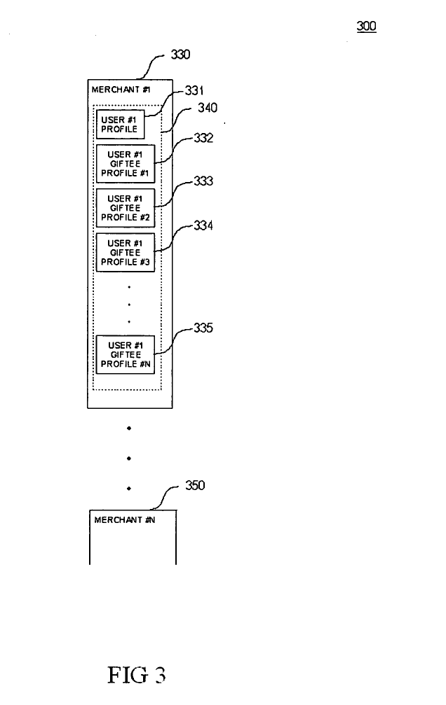

In accordance with additional exemplary embodiments, as shown for example, in FIG. 3, profiles may be established in scenario 300, for multiple giftees. As before, user #1 113 may connect to Internet 120 in a conventional manner whereupon one or more on-line transactions may be conducted with one or more merchants, such as merchant #1 330 and up to merchant N 350. Within merchant #1 330, user #1 global profile 340 may contain aggregated transaction and preference related information associated with user #1 preferences in user #1 profile 331. Profiles for multiple giftees may be maintained and updated and information associated with corresponding transactions otherwise aggregated in user #1 giftee profile #1 332, user #1 giftee profile #2 333, user #1 giftee profile #3 334, and user #1 giftee profile #N 335.

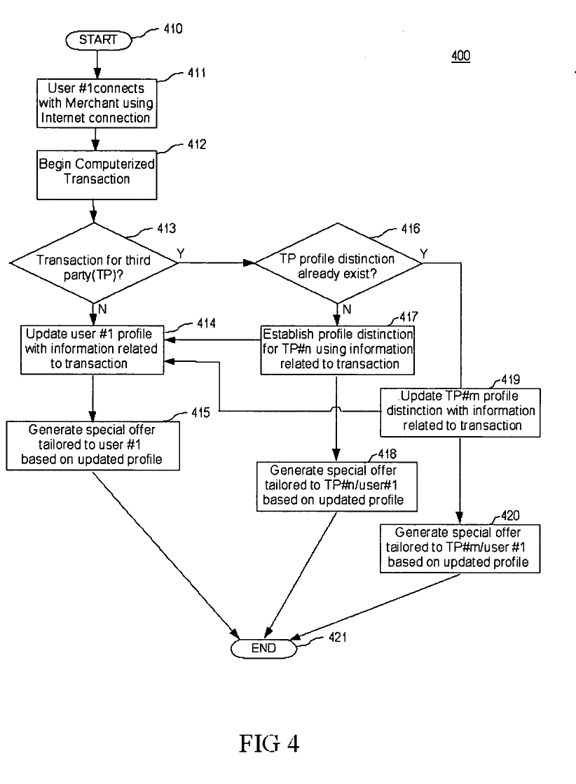

In accordance with various exemplary and alternative exemplary embodiments, FIG. 4 shows procedures of a method in a flow chart. After start at 410, user #1 113 connects at 411 with a merchant using an Internet connection as described herein above. At 412 a computerized transaction over the Internet connection may begin at which time the merchant may pull up information associated with user #1 113 including a profile and profile distinctions associated with third parties. If the transaction is determined to be at 413 for a TP, which determination may be made using a number of methods including an on-line prompt, a determination that the “ship to” party does not match the user, and the like, then a further determination is made at 416 as to whether a profile distinction already exists for that TP. If the profile distinction does exist, then it is updated with information related to the transaction at 419, otherwise, a new profile distinction may be established for the TP, e.g. TP#n at 417. At 418, any special offer, promotion or the like, based on the profile distinction may be presented at 418. It will be appreciated that for TP#n, since the profile distinction contains only information related to the present transaction, the degree of specificity will below until more information is gathered and aggregated. However, if sufficient information exists in the profile for user#l, it is possible that more detailed and specific offerings may be made using, to the extent relevant, the information aggregated in the profile for user #1. Over time, additional transactions will improve the quality of the profile distinction for TP#n. In a similar manner, at 20, a special offer or promotion may be presented based on the aggregated profile distinctions for TP#m. It can also be seen that at both 417 and 419, profile distinction information may be applied or otherwise aggregated into the profile for user #1, e.g. in a manner which distinguishes the information from the general or individual profile for user #1, based on the fact that the transaction is conducted on behalf of a third party. After promotions or the like have been presented the procedure can be ended at 421.

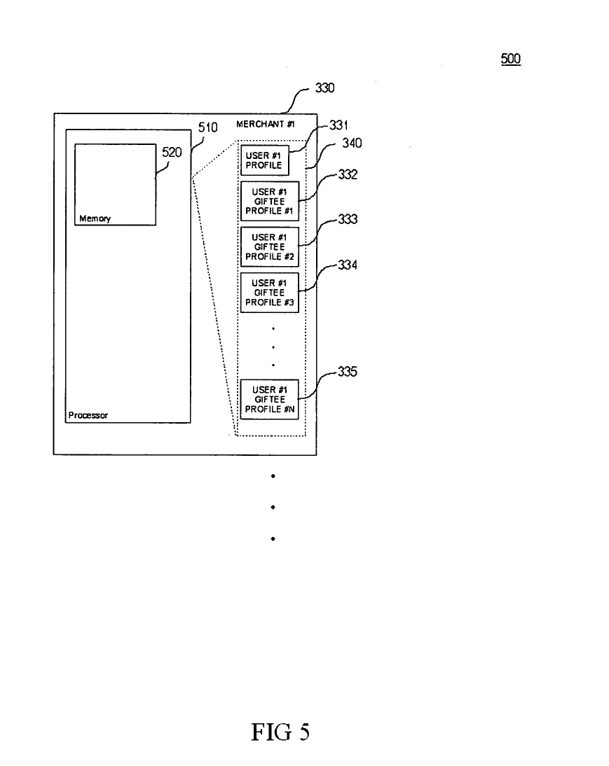

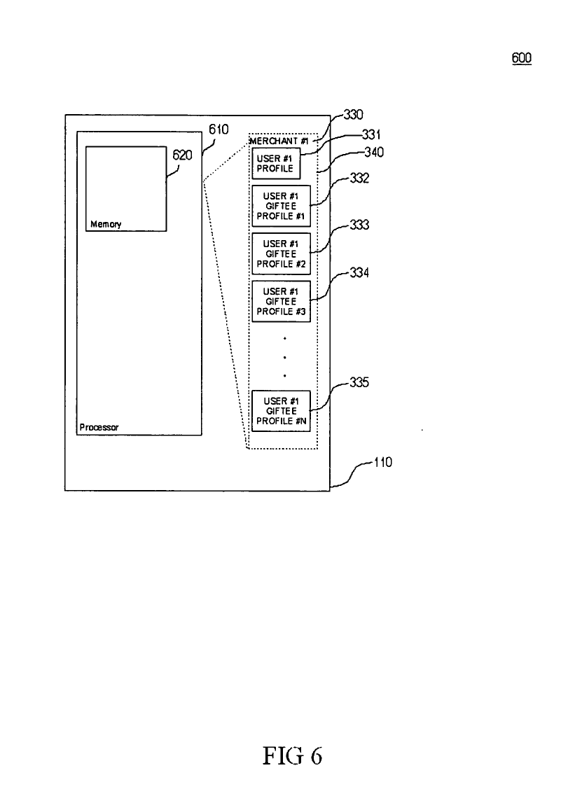

It will be appreciated by those of ordinary skill in the art that the method of the present invention may be implemented by w ay of instructions, for example, as might be carried on a computer readable media, for causing a processor to carry out various procedures in accordance therewith. FIG. 5, for example, shows merchant #1 330 having processor 510 with memory 520. Processor 510 may be configured to store instructions, for example, in memory 520 which cause processor 510 to carry out various procedures associated with aggregating information for user #1 profile 331, and giftee profiles 332-335, for example, in accordance with the flow chart illustrated in FIG. 4. Similarly, as shown in FIG. 6, information associated with aggregated profiles may be kept on computer 110 associated with user 113, for example, at user 113's premises, or a laptop or the like associated with user 113, may be equipped with processor 610 and memory 620. Processor 610 may be configured to store instructions, for example, in memory 620 which cause processor 610 to carry out various procedures associated with aggregating information for user #1 profile 331, and giftee profiles 332-335, for example, in accordance with the flow chart illustrated in FIG. 4. In such an instance, information associated with user #1 profile 331, giftee profiles 332-335, or global profile 340, may be transferred to a merchant, such as merchant #1 330 over the Internet connection as described herein above, once a computerized transaction has begun.

It is believed that the method of the present invention and many of its attendant advantages will be understood by the forgoing description. It is also believed that it will be apparent that various changes may be made in the form, construction and arrangement of the processes and steps associated therewith without departing from the scope and spirit of the invention or without sacrificing all of its material advantages. The form herein before described being merely an explanatory embodiment thereof. It is the intention of the following claims to encompass and include such changes.

1. A method for generating a profile distinction associated with a computerized transaction between a user and a merchant, the method comprising:
determining if the computerized transaction is associated with the user or if the computerized transaction is associated with the user on behalf of a third party;
aggregating information associated with the transaction in a profile corresponding to the user if the computerized transaction is determined to be associated with the user; and
aggregating the information associated with the transaction in the profile corresponding to the user according to a profile distinction associated with the third party if the computerized transaction is determined to be associated with the third party.

2. The method according to claim 1, further comprising:
presenting one or more of: a special offer, a promotion, a product offering, a product recommendation, and a product suggestion, tailored to one or more of the user and the third party using the aggregated information associated with the transaction.

3. The method according to claim 1, further comprising:
determining if the profile distinction associated with the third party is already present in the profile;
establishing the profile distinction associated with the third party if the profile distinction is not already present in the profile; and
aggregating the information associated with the transaction in the profile distinction associated with the third party if the profile distinction is already present in the profile.

4. An apparatus for generating a profile distinction associated with a computerized transaction between a user and a merchant in a computer associated with the user, the apparatus comprising:
a network interface;
a processor; and
a memory coupled to the processor and the network interface, the memory storing instructions for causing the processor to:
determine if the computerized transaction is associated with the user or if the computerized transaction is associated with the user on behalf of a third party;
aggregate information associated with the transaction in a profile corresponding to the user if the computerized transaction is determined to be associated with the user; and
aggregate the information associated with the transaction in the profile corresponding to the user according to a profile distinction associated with the third party if the computerized transaction is determined to be associated with the third party.

5. The apparatus according to claim 4, wherein the instructions further cause the processor to:
present one or more of: a special offer, a promotion, a product offering, a product recommendation, and a product suggestion, tailored to one or more of the user and the third party using the aggregated information associated with the transaction.

6. The apparatus accordihg to claim 4, wherein the instructions further cause the processor to:
determine if the profile distinction associated with the third party is already present in the profile;
establish the profile distinction associated with the third party if the profile distinction is not already present in the profile; and
aggregate the information associated with the transaction in the profile distinction associated with the third party if the profile distinction is already present in the profile.

7. An apparatus for generating a profile distinction associated with a computerized transaction between a user and a merchant in a computer associated with the merchant, the apparatus comprising:
a network interface;
a processor; and
a memory coupled to the processor and the network interface, the memory storing instructions for causing the processor to:
determine if the computerized transaction is associated with the user or if the computerized transaction is associated with the user on behalf of a third party;
aggregate information associated with the transaction in a profile corresponding to the user if the computerized transaction is determined to be associated with the user; and
aggregate the information associated with the transaction in the profile corresponding to the user according to a profile distinction associated with the third party if the computerized transaction is determined to be associated with the third party.

8. The apparatus according to claim 7, wherein the instructions further cause the processor to:
present one or more of: a special offer, a promotion, a product offering, a product recommendation, and a product suggestion, tailored to one or more of the user and the third party using the aggregated information associated with the transaction.

9. The apparatus according to claim 7, wherein the instructions further cause the processor to:
determine if the profile distinction associated with the third party is already present in the profile;
establish the profile distinction associated with the third party if the profile distinction is not already present in the profile; and
aggregate the information associated with the transaction in the profile distinction associated with the third party if the profile distinction is already present in the profile.
